(19) United States
(12) Patent Application Publication
(10) Pub. No.: US 2026/0197542 A1
(43) Pub. Date: Jul. 9, 2026

(54) EMBEDDED MODULE AND 360-DEGREE CAMERA-INTEGRATED 360-DEGREE STREAMING DEVICE

(71) Applicant: SERDIC, Inc., Busan (KR)

(72) Inventors: Hoi Jun KIM, Seoul (KR); Hyeon Yong SON, Gwangju-si (KR); Jin Kyu KANG, Seoul (KR); Jae Ung JEONG, Daegu (KR); Choong Hee PARK, Daejeon (KR)

(21) Appl. No.: 19/393,840

(22) Filed: Nov. 19, 2025

(30) Foreign Application Priority Data
Jan. 6, 2025 (KR) 10-2025-0001419

(51) Int. Cl. H04N 23/51; G03B 17/56; G08B 21/12; H04N 23/695

(52) U.S. Cl. CPC H04N 23/51; G03B 17/561; G03B 17/563; G08B 21/12; H04N 23/695

(57) ABSTRACT

The present disclosure relates to an embedded module and 360-degree camera-integrated 360-degree streaming device. The 360-degree streaming device includes a housing having an inner space enclosed by an upper wall, a lower wall, and both side walls, in which the inner space of the housing includes a module mounting space formed to mount the embedded module, a battery storage space formed at one side of the module mounting space, and a wired line extension space formed at a right side of the module mounting space, a camera connection unit to which the 360-degree camera is coupled is formed on the upper wall of the housing, and a handle is coupled to at least one of the both side walls to allow an operator to hold and carry the housing.

### CROSS-REFERENCE TO RELATED APPLICATIONS

This application claims the benefit of and priority to Korean Patent Application No. 10-2025-0001419 filed on Jan. 6, 2025, in the Korean Intellectual Property Office, the disclosure of which is incorporated herein by reference in its entirety.

### BACKGROUND

### Field

The present disclosure relates to an embedded module and 360-degree camera-integrated 360-degree streaming device, and more particularly, to a 360-degree streaming device which supports stable installation of internal component, such as an embedded module, enables coupling of a 360-degree camera, enhances the mobility of an operator, and supports the coupling with various environment sensors and devices.

### Description of the Related Art

A digital twin technology is a technology which generates a virtual replica of a physical asset or system to analyze and simulate the virtual replica based on real-time data and is utilized as a tool for monitoring a state of the physical system in real time, predicting a potential problem, and maximizing maintenance and operational efficiency. Specifically, in the field of industrial facilities, the digital twin technology plays an important role in suppressing unexpected failure or enabling operational optimization by monitoring a state of the facility and analyzing operational data by utilizing various sensors and devices.

Traditionally, in the industrial sites, data has been mainly collected using fixed cameras and individual sensors. In this case, the collected data is transmitted to a separate server or device to be manually analyzed and processed by an operator. For example, in order to manually review image data captured by a camera or identify a problem occurring in the field, various individual devices are combined to be utilized. The existing system as described above has a limited real-time data processing and analyzing capability and has a limitation of degradation of task efficiency and accuracy.

Further, the fixed camera-based system of the related art has difficulty in responding quickly to changes in the environment around the facility and requires a complex operation when the position of the camera is changed or an additional device is installed. This may cause the operator to consume a lot of time during a process of replacing a camera or a sensor and deteriorate the task efficiency. The existing technology has lacked consideration of housing design or device integration and therefore failed to provide a structure which protects and securely moves a handle or a device which can be moved by the operator.

Further, in the system of the related art, there was no case in which an embedded module which processed and analyzed data in real time was integrated in the housing. The fixed facility of the related art relied on separate servers or external devices for data processing, which acted as a limiting factor of a processing speed and real-time responsiveness. By doing this, the installation and maintenance process was inefficient.

In conclusion, the existing technology has a structural limitation to collect data using a fixed camera and sensor and manually analyze the data using an external device, which makes it difficult to process data in real time and flexibly respond to environmental changes. Further, a structure which easily moves the equipment or an integrated system which processes data in real time cannot be provided so that the work efficiency is low and an additional effort for maintenance is required. In order to solve this problem, a technology in which a housing structure with a handle which can be easily moved by the operator and an embedded module which enables real-time data collection and processing are integrated is requested.

### SUMMARY

An object of the present disclosure is to provide a 360-degree streaming device in which an embedded module is securely installed and a 360-degree camera is designed to be coupled to a housing and implement a structure coupled with a handle which allows an operator to easily hold and carry the 360-degree streaming device.

The present disclosure relates to an embedded module and 360-degree camera integrated 360-degree streaming device. The 360-degree streaming device includes a housing having an inner space enclosed by an upper wall, a lower wall, and both side walls, in which the inner space of the housing includes a module mounting space formed to mount the embedded module, a battery storage space formed at one side of the module mounting space, and a wired line extension space formed at a right side of the module mounting space, a camera connection unit to which the 360-degree camera is coupled is formed on the upper wall of the housing, and a handle is coupled to at least one of the both side walls to allow an operator to hold and carry the housing.

According to an exemplary embodiment of the present disclosure, first to fourth fitting protrusions which fix four corners of the embedded module may be formed in the inner space of the housing, the first and third fitting protrusions may downwardly protrude while being spaced apart from each other in a width direction in the upper wall of the housing, and the second and fourth fitting protrusions may upwardly protrude while being spaced apart from each other in a width direction in the lower wall of the housing.

According to an exemplary embodiment of the present disclosure, and in the embedded module, first to fourth engagement surfaces may be formed on corners of the embedded module to be engaged with the first to fourth fitting protrusions, respectively.

According to an exemplary embodiment of the present disclosure, the first and second fitting protrusions may divide the module mounting space and the battery storage space and the third and fourth fitting protrusions may divide the module mounting space and the wired line extension space.

According to an exemplary embodiment of the present disclosure, a camera connection unit formed on the upper wall of the housing may be recessed to allow a lower end of the 360-degree camera to be mounted, and a direction switching hole for switching a direction of the 360-degree camera and a fixing hole for fixing the 360-degree camera may be formed on an inner surface of the recess to couple the 360-degree camera to be detachable and switch the direction.

According to an exemplary embodiment of the present disclosure, first and third inclined surface may be formed between the upper wall and both side walls of the housing and second and fourth inclined surfaces may be formed between the lower wall and both side walls of the housing, the first and third inclined surfaces may connect the upper wall and the both side walls of the housing, and the second and fourth inclined surfaces may connect the lower wall and both side walls of the housing to allow edges of the housing to be smoothly continued.

According to an exemplary embodiment of the present disclosure, first and second antenna coupling units to which an antenna is detachably coupled may be formed on the first and third inclined surfaces formed between the upper wall and both side walls of the housing and the first and second antenna coupling units may be formed as through holes to include a screw thread therein and the antenna may be screwed with the housing through the screw thread.

According to an exemplary embodiment of the present disclosure, the battery storage space formed in the inner space of the housing may have a right side restricted by a first fitting protrusion and a second fitting protrusion of the housing and a left side enclosed by the left side wall of the housing to securely accommodate a battery.

According to an exemplary embodiment of the present disclosure, the wired line extension space formed in the inner space of the housing may have a left side restricted by the third fitting protrusion and the fourth fitting protrusion of the housing and a right side enclosed by the right side wall of the housing to organize and protect a wired line.

According to an exemplary embodiment of the present disclosure, a screw hole may pass through the lower wall of the housing to fix the housing to a tripod.

According to an exemplary embodiment of the present disclosure, an LED coupling unit and a gas sensor coupling unit may be formed on the upper wall of the housing with the camera connection unit therebetween, be formed to have a recess structure which is inwardly dented from the upper wall of the housing, and be coupled to a fixture which fixes an LED and a gas sensor in the recess.

According to an exemplary embodiment of the present disclosure, each of handles formed on both side walls of the housing may include a hand insertion space to which the user's hand is inserted and the hand insertion space may be enclosed by a vertical extension portion which is spaced apart from the side wall of the housing, an upper inclined portion which connects an upper end of the vertical extension portion and an upper end of the side wall of the housing, and a lower inclined portion which connects a lower end of the vertical extension portion and a lower end of the side wall of the housing.

According to an exemplary embodiment of the present disclosure, a locking device hole which passes through the lower inclined portion may be formed and allow a locking device to be coupled to restrict the movement of the housing.

According to the present disclosure, the 360-degree streaming device can have various structural and functional advantages, thereby effectively overcoming the limitation of the existing technology.

First, the handle provided in the housing of the 360-degree streaming device is designed to allow an operator to easily move the device, thereby significantly improving the mobility. Such a handle structure reduces a fatigue during the operation and provides flexibility which quickly responds to the environmental changes. Further, the handle is designed to securely protect the components in the housing and maintain the part so as not to be shaken even by the impact which may occur during the movement.

Second, a fitting protrusion is provided in the housing to securely fix internal components including an embedded module. The fitting protrusion increases the structural stability in the housing and protects the embedded module and other parts so as not to be damaged during the movement. A battery storage space and a wired line extension space are separately designed to increase the inner space availability and suppress the interference between the electronic parts.

Third, a structure which couples the 360-degree camera and an antenna can be included above the housing to collect and analyze external environment data in real time. Specifically, the 360-degree camera is designed to switch the direction and be detachable to increase the availability in a multi-purpose environment. By doing this, the operator may collect and process data in various environments.

Fourth, the housing includes a structure which is coupled with a tripod to be stably used in a fixed state. This design enables flexible application in both a fixed work environment and a movable work environment.

In conclusion, the 360-degree streaming device of the present disclosure is a system which comprehensibly satisfies data collection, processing, and mobility and can provide a basis for efficiently implementing a digital twin technology in an industrial site and simultaneously improve work efficiency and safety.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating components of a 360-degree image real-time streaming and environment analysis system according to the present disclosure.

FIG. 2 is a view illustrating a path through which a result analyzed by an AI computation module, among components of FIG. 1 and an alarm when an outlier occurs are transmitted to an operator or a remote user.

FIG. 3 is a view illustrating each process of a real-time biometric data estimation technique which is applied to an AI computation module, among components of FIG. 1.

FIG. 4 is a view illustrating a path through which a result analyzed by a sensor analysis module, among components of FIG. 1 and an alarm when an outlier occurs are transmitted to an operator or a remote user.

FIG. 5 is a view illustrating a state in which a housing for coupling an embedded module and a 360-degree camera is coupled to a cover, in a 360-degree streaming device according to the present disclosure.

FIG. 6 is a view illustrating a state in which a housing of FIG. 5 is separated from a cover.

FIG. 7 is a plan view of a housing according to the present disclosure.

FIG. 8 is a top view of a housing according to the present disclosure.

FIG. 9 is a bottom view of a housing according to the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Specific contents for implementing the present disclosure will be described with reference to the following accompanying drawings. In addition, when explaining the present disclosure, if it is judged that the relevant known functions are obvious to those skilled in the art and may unnecessarily obscure the gist of the present disclosure, a detailed description thereof will be omitted.

First, a 360-degree image real-time streaming and environment analysis system including a 360-degree streaming device according to the present disclosure will be described first, and then the housing will be described in detail.

First, the 360-degree image real-time streaming and environment analysis system will be described as follows.

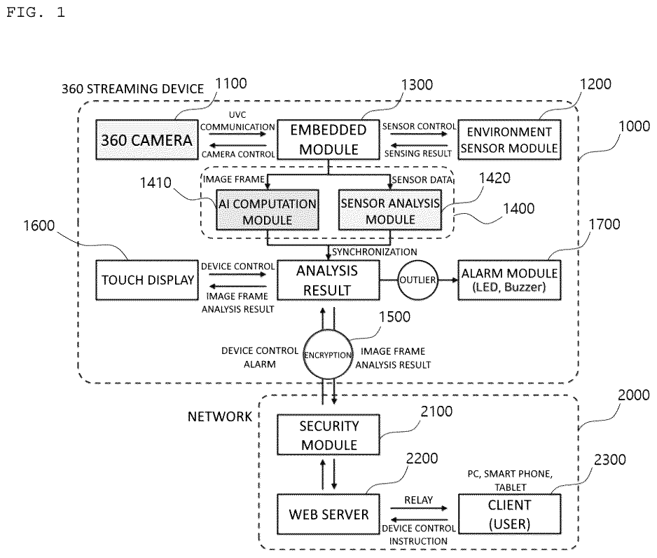

FIG. 1 is a view illustrating each component of a 360-degree image real-time streaming and environment analysis system according to the present disclosure.

Referring to FIG. 1, the 360-degree image real-time streaming and environment analysis system is configured by a 360-degree streaming device 1000 and a network 2000. The 360-degree streaming device 1000 is configured by various modules which collect and process a 360-degree image and environment data of a workplace and transmit data to a web server via a security module through the network 2000 to allow the client terminal 2300 to check the data in real time. This connection enables remote real-time monitoring and analysis.

The 360-degree streaming device 1000 may include a 360-degree camera 1100, an environment sensor module 1200, an embedded module 1300, a data analysis unit 1400 having an AI computation module 1410 and a sensor analysis module 1420, an encryption module 1500, a touch display 1600, and an alarm module 1700. The network 2000 may include a security module 2100, a web server 2200, and a client terminal 2300.

The 360-degree camera 1100 serves to acquire a 360-degree image of a workplace in real time to transmit the 360-degree image to the embedded module 1300. For example, a high-performance camera, such as the Ricoh 360 camera, simultaneously captures images at various angles using a plurality of lenses to provide an omnidirectional 360-degree image, thereby monitoring an activity of the operator and a change in a surrounding environment in real time. This capturing method is utilized to quickly identify risk factors which may be caused in the workplace and is advantageous to check the number of operators and compare before and after the work.

The 360-degree camera 1100 may support various resolutions, such as 1 K, 2 K, and 4 K and the user may select an appropriate image quality according to a work environment and a network condition. 4 K of high resolution image enables clear identification of details of the workplace to be effective for security surveillance and safety management and 1 K of low resolution image provides smoother streaming by reducing a network bandwidth to be suitable for real-time monitoring.

The collected image may be transmitted to the embedded module 1300 in real time through a USB video class (UVC) protocol and the embedded module may process and analyze the corresponding data. The 360-degree camera 1100 may omnidirectionally monitor all the angles of the workplace to provide an important basis to analyze risks which may occur while an operator moves or performs a specific task in real time. Further, the 360-degree camera may be linked with Jetson Nano to interwork with a deep-learning-based AI solution to perform an advanced function, such as biometric data analysis and work situation recording.

The 360-degree camera 1100 system may be operable by power connection or a battery pack and supports water-resistant function to be stably operated in various work environments. The client terminal 2300, such as a smart phone or a tablet, may immediately check the workplace through router equipment and an alarm notification function may enable quick response when a problem occurs in the site.

The environment sensor module 1200 collects various environment data of the workplace in real time to maintain the safety of the workplace. The environment sensor module 1200 consistently monitors data, such as a gas concentration, a temperature, a humidity, or a pressure, and collects data in real-time to detect potential risk factors which may occur in the work environment in early stages.

The collected environment data is transmitted first to the embedded module 1300, and then is transmitted to the sensor analysis module 1420. The sensor analysis module 1420 analyzes the environment data transmitted through the embedded module 1300 in real time to quickly detect an outlier or a dangerous situation. For example, if the gas concentration exceeds a predetermined threshold, the sensor analysis module 1420 may immediately generate a warning signal to warn the operator or a manager through the alarm module 1700.

The environment sensor module 1200 is very useful, particularly for a factory or a site where dangerous materials are used and provides a function of analyzing data in real time for an operator so as not to be dangerous and issuing an instant warning if necessary. By doing this, the workplace may be more safely maintained.

Further, the collected environment data is encrypted to be transmitted to the web server 2200 through the embedded module 1300 and the sensor analysis module 1420 so as to be monitored in real time from a remote place. A manager or an operator in a remote place may check the environment state of the workplace in real time through this system and may respond immediately when an abnormality is detected.

The embedded module 1300 serves to process and transmit the 360-degree image and the environment data in real time. The embedded module 130 integrates and processes data collected from the 360-degree camera 1100 and the environment sensor module 1200, and then transmits the data to the AI computation module 1410 and the sensor analysis module 1420.

First, the embedded module 1300 receives and processes images having resolutions of 1 K, 2 K, and 4 K transmitted from the 360-degree camera 1100 through a USB video class (UVC) protocol. The embedded module 1300 may select an optimal resolution in accordance with the network bandwidth and the processing demand. Further, the embedded module receives and real-time monitors the environment data, such as a gas concentration, a temperature, a humidity, or a pressure collected by the environment sensor module 1200.

The embedded module 1300 processes collected data and then transmits the collected data to the sensor analysis module 1420 to allow the sensor analysis module to analyze the data in real time. If the gas concentration exceeds a predetermined threshold or an abnormal situation of the work environment is detected, the sensor analysis module 1420 generates a warning signal and warns the operator and the manager through the alarm module 1700.

During this process, the embedded module 1300 serves to transmit and process data and finally, the AI computation module 1410 and the sensor analysis module 1420 analyze data and detect a dangerous situation. Further, all the data is encrypted to be transmitted to the web server 2200 and the state of the workplace may be monitored in real time even in a remote place. A manager or an operator in a remote place may check the environment state of the workplace through this and may respond immediately when an abnormality is detected. Consequently, the embedded module 1300 plays an important role in processing the data in real time and transmitting the processed data to the data analysis unit 1400, thereby maintaining the safety of the workplace.

The data analysis unit 1400 serves to analyze image and environment data collected from the workplace in real time and detect the dangerous situation. The data analysis unit 1400 is configured by the AI computation module 1410 and the sensor analysis module 1420 and analyzes the condition of the operator and the environment data to immediately generate a warning signal when the risk is detected.

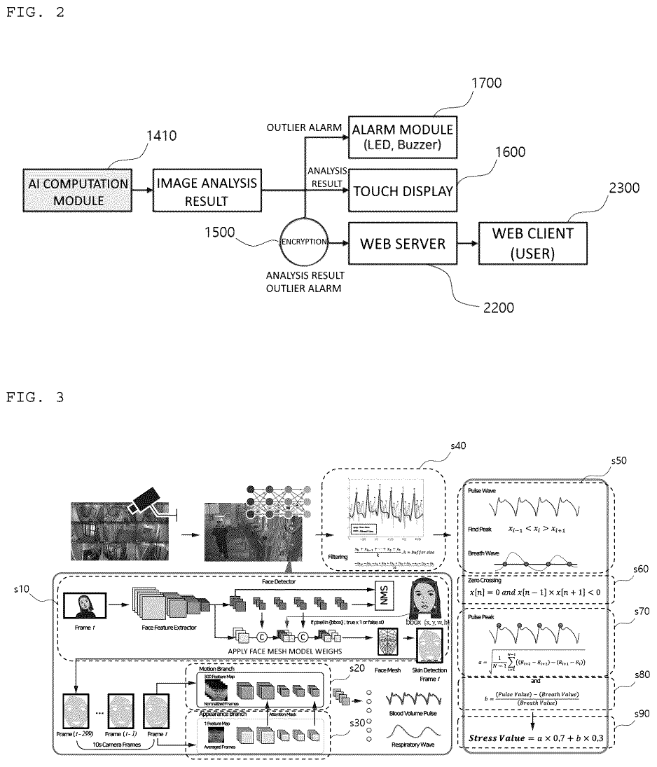

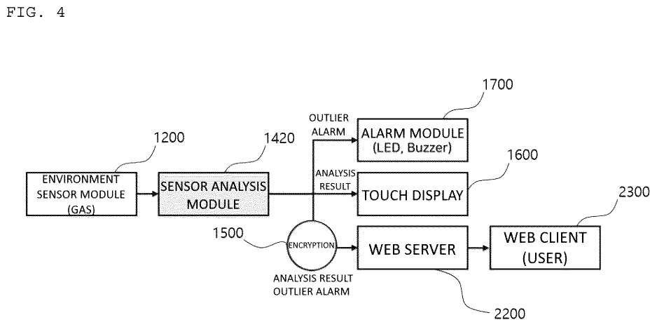

FIG. 2 is a view illustrating a path through which a result analyzed by an AI computation module, among components of FIG. 1 and an alarm when an outlier occurs are transmitted to an operator or a remote user. FIG. 3 is a view illustrating each process of a real-time biometric data estimation technique which is applied to an AI computation module, among components of FIG. 1.

Referring to FIGS. 2 and 3, the AI computation module 1410 plays an important role in analyzing an image transmitted in real time from the 360-degree camera 1100 to estimate biometric data of the operator. This module detects a face through the deep learning-based algorithm and extracts main feature of a face by utilizing face mesh or face detector technology in step s10. By doing this, a blood volume pulse (BVP) and a respiratory cycle may be estimated and a biometric condition of the operator may be analyzed.

During this process, a motion branch s20 and an appearance branch s30 operate together. The motion branch serves to capture a pattern which finely changes over time in the real-time image and measures a fine change of a face surface to analyze a pulse and respiration. Specifically, the pulse is analyzed based on a fine skin color change which occurs due to a change in the blood flow and an expansion and contraction pattern of the face skin may be temporally analyzed to infer the respiration speed. The appearance branch is used to extract visual static information from each frame and extracts a common feature of input accumulated frames to analyze positions of the face and the skin in the frame.

The attention mask selects a main area to be analyzed to filter an unnecessary background and emphasizes important spatial and temporal features. By doing this, the model extracts a feature mainly from a skin area, rather than the entire image, to increase the accuracy of the biometric signal analysis.

After face detection, a region of interest is set and at this time, face regions in the frames are aligned by utilizing a rotation value of the face. The alignment process improves the performance of the biometric data analyzer and the rotation value of the face is calculated horizontally and vertically based on coordinates of eyes, nose, and mouth. During this process, the rotation of the face region is calculated such that eyes are horizontally aligned and the nose and the mouth are vertically aligned. Next, the skin region is calculated again in the region of interest of the face, which improves the accuracy of the biometric data analyzer by setting a remaining skin region excluding the eyes, the eyebrow, and the mouth by utilizing a landmark coordinate obtained after detecting a face mesh and removing a background.

The entire process of FIG. 3 is configured by acquiring images, detecting a face, calculating a skin region, analyzing pulse and respiratory waveforms, filtering a waveform noise removal, digitizing (the number of times per minute), and analyzing a stress index.

During the waveform analysis process, waveform noise removal filtering is performed in step s40. Here, a moving average filter and a Conv filter are applied. First, the moving average filter processes data by the following Equation to remove a basic noise.

$$\frac{{x}_{10} + {x}_{9} + {x}_{8} + {x}_{7} + {x}_{6} + {x}_{5} + {x}_{4} + {x}_{3} + {x}_{2} + {x}_{1}}{10} \qquad [ Equation 1 ]$$

Each x represents a value of an input signal. These values are signal samples which are arranged in a chronological order in which x₁ is the oldest sample and x₁₀ is the newest sample. These values are continuously measured data and represent 10 samples obtained from an original signal before filtering. In Equation, 10 is a divisor used to calculate an average and in this case, an average is calculated from 10 samples, so that the values are divided by 10. That is, all 10 sample values are added and then divided by 10 to obtain an average. By doing this, fluctuations of the short-term signals are averaged to reduce a noise in a part where the signal fluctuation is severe and make the signal smooth.

The Conv filter removes the noise while maintaining a peak and a trend of the waveform by the following Equation. The Conv filter is applied to a one-dimensional array and is appropriate to process time-series data with the similar principle to an artificial intelligence convolution operation.

$$\frac{1}{10} ( - 3 {x}_{10} - 2 {x}_{9} - {x}_{8} + 3 {x}_{7} + 7 {x}_{6} + 7 {x}_{5} + 3 {x}_{4} - {x}_{3} - 2 {x}_{2} - 3 {x}_{1} ) \qquad [ Equation 2 ]$$

Each x represents a value of an input signal. These values are signal samples which are arranged in a chronological order in which x₁ is the oldest sample and x₁₀ is the newest sample. That is, the recent 10 samples of the input signal are used for the filtering process. The number prefixed to each signal sample indicates a weight assigned to the sample. The weight determines how significantly the sample is processed during the filtering.

1/10 preceding Equation serves to scale the result. This is a task of dividing the sum of the samples assigned with the weight by 10 to calculate an average. This value serves to control the overall value so that the filtering result is not excessively large. In Equation 2, the weights are configured by −3, −2, −1, 3, and 7 and this pattern effectively catches the change of the signal by emphasizing or softening a specific pattern of the signal.

Next, the pulse rate per minute is changed to a pulse rate per minute by analyzing the number of peaks of the waveform in step s50. A current value is compared with a previous value and a subsequent value in the waveform and the peak is represented to be larger than the previous value and the subsequent value and forms an apex of the waveform. During this process, the following Equation is used.

$$x [ n - 1 ] < x [ n ] and x [ n + 1 ] < x [ n ] \qquad [ Equation 3 ]$$

The respiration rate is converted to a respiration rate per minute by calculating a zero-crossing point. The zero-crossing calculates a cycle of inhalation and exhalation based on the number of points at which the waveform meets zero and the zero-crossing point is calculated by the following Equation.

$$x [ n ] = 0 and x [ n - 1 ] \times x [ n + 1 ] < 0 \qquad [ Equation 4 ]$$

Additionally, the stress index is calculated by analyzing pulse variability and the correlation between the pulse and the respiration. When a stress is applied, the pulse becomes constant and in a normal state, the pulse varies so that it is determined that the more diverse the pulse waveform is, the lower the stress index becomes. Further, the imbalance between the pulse and the respiration may indicate the stressed state.

The stress index is calculated by the following Equation in step s70. The following Equation is root mean square of successive differences (RMSSD) and evaluates the pulse variability.

$$a = \sqrt{\frac{1}{N - 1} {\sum }_{i = 1}^{N - 1} ( ( {R}_{i + 2} - {R}_{i + 1} ) - ( {R}_{i + 1} - {R}_{i} ) )} \qquad [ Equation 5 ]$$

In the above Equation, N indicates a total number of R-R intervals. The R-R interval indicates a time interval between two consecutive electrocardiogram signals (that is, two heartbeats) in which heart rate is generated. This value is a total number of heartbeat intervals in the Equation and an average value calculated in Equation is adjusted thereby.

Rᵢ₊₂, Rᵢ₊₁, and Rᵢ indicate continuous heartbeat intervals. These values refer to time intervals at which each heartbeat occurs and are referred to as an R-R interval. For all the sections from i=1 to N−1, the difference (Rᵢ₊₂−Rᵢ₊₁)−(Rᵢ₊₁−Rᵢ) is calculated and the results are added. The equation calculates a value indicating heart rate variability by squaring the difference of consecutive heartbeat intervals (R-R interval) to get an average and converting the result into the square root of the value.

The larger RMSSD value represents that the heartbeats occur at more various intervals, which indicates that the heart responds more appropriately. In contrast, the low RMSSD value represents that the heart rate variability is small and is followed by a continuous heart rate interval and is a result obtained when a stress is high and a health condition is not good.

Further, a correlation value of pulse and respiration is analyzed by the following Equation in step s80.

$$b = \frac{( Pulse Value ) - ( Breath Value )}{( Breath Value )} \qquad [ Equation 6 ]$$

In the above Equation, pulse value refers to a pulse value. This indicates a heart rate per minute and is deduced based on the previously measured pulse data. Generally, it is calculated based on the number of peaks of the pulse. Breath value refers to a respiration value. This indicates a respiration rate per minute and is deduced by measuring a respiratory cycle by means of the zero-crossing in a breath curve. That is, it is a value obtained by calculating the respiration rate per minute based on the crossing point of inhalation and exhalation.

In the above Equation, a difference between the pulse value and the breath value is divided by the breath value. This is a process of normalizing a difference of two values based on the breath value to evaluate the relative difference between the pulse and the respiration. This value indicates the correlation of the pulse and the respiration and helps to evaluate the stress state. The large value means that the pulse and the respiration are not significantly consistent.

Finally, the stress index is calculated by the following Equation in step s90.

$$Stress Value = a \times 0.7 + b \times 0.3 \qquad [ Equation 7 ]$$

In the above Equation, the stress value is calculated by assigning weights to a value a (variability of a pulse) and a value b (inconsistency between pulse and respiration). a×0.7 plays an important role in the pulse variability and b×0.3 plays an auxiliary role by considering the correlation between the pulse and the respiration. The higher the stress value, the higher the stress and there may be a possibility of an unstable state of the body. In contrast, the smaller the value, the lower the stress and the more stable the physical condition.

By doing this, the AI computation module 1410 may evaluate and analyze a stress level of an operator in real time.

The image-based biometric data analysis technique operates in a non-contact manner so that a health condition of an operator may be monitored without an additional sensor. This technology is effective not only for safety management, but also for stress management and health condition checks of the operator. Specifically, the real-time streaming and analysis functions may enable the immediate response and this technology may be effectively utilized in various industrial sites and security systems.

FIG. 4 is a view illustrating a path through which a result analyzed by a sensor analysis module, among components of FIG. 1 and an alarm when an outlier occurs are transmitted to an operator or a remote user.

Referring to FIG. 4, the sensor analysis module 1420 analyzes environment data, such gas concentration, a temperature, a humidity, and a pressure collected from the environment sensor module 1200 in real time. If an environmental change which exceeds a predetermined threshold occurs, the sensor analysis module 1420 immediately generates a warning signal. For example, when a harmful gas concentration reaches a dangerous level, the sensor analysis module immediately generates a warning signal to notify an operator and a manager. This warning is also transmitted from the site through the alarm module 1700 and at the same time, is transmitted to the web server 2200 in an encrypted form so that a remote user may also monitor the environment state of the workplace in real time.

The encryption module 1500 is a security factor and is used to securely transmit 360-degree image data and environment data. Data collected by various sensors and the 360-degree camera 1100 is processed in the embedded module 1300 and the data analysis unit 1400, and then is transmitted to the remote user through the web server 2200. During this process, in order to prevent sensitive data from being leaked to the outside or accessed without authorization, the encryption module 1500 encrypts the data to be securely transmitted.

The encryption module 1500 encrypts data analyzed in the AI computation module 1410 and the sensor analysis module 1420 in real time. For example, all the data are encrypted to securely protect not only sensitive information, such as operator's face respiration, or pulse condition, but also the recognition, environment data, such as a gas concentration, a temperature, or a humidity. The encrypted data is transmitted through a network, thereby securely protecting the data from threats from the outside.

Further, the encryption module 1500 ensures the security in the communication between the web server 2200 and the client terminal 2300. When the client terminal 2300 remotely monitors data or receives a notification, the data is securely transmitted through an encryption protocol, such as SSL/TLS. For example, when the AI computation module 1410 detects a dangerous situation of the operator or the sensor analysis module 1420 detects an environment data outlier, the alarm signal is generated and is encrypted to be transmitted so that the remote user may securely receive the warning.

As a result, the encryption module 1500 securely protects all the generated data and maintains the integrity and the confidentiality of the data while being transmitted on the network to block intrusion or threats from the outside. By doing this, the system ensures the security while enabling the real-time monitoring and warning reception from the remote place.

The touch display 1600 serves to provide a user interface to monitor the condition of the workplace in real time. The user may immediately check the state of the system, the streaming image, the AI analysis result, and environment sensor data through the touch display 1600 and a result based on the analyzed data is also displayed in real time. The user may quickly identify a generated abnormal situation through the touch display 1600 and take an immediate action if necessary. For example, when the AI computation module detects an abnormal respiration of the operator or the risk factor, the information is visually displayed on the touch display 1600 and the operator may recognize and respond to this. Further, the touch display 1600 also provides an intuitive user experience to help real-time management of the work environment without a complex system setting.

The alarm module 1700 is an element which transmits a visual or auditory warning for an abnormal situation occurring in the workplace. The alarm module 1700 is configured by a physical device, such as a processor, an LED, or a buzzer and immediately operates when the AI computation module 1410 or the sensor analysis module 1420 detects a dangerous situation. For example, when the gas sensor detects a harmful gas having a dangerous concentration or the AI computation module 1410 identifies an abnormal behavior of the operator, the alarm module 1700 is activated to generate a warning sound or light up a warning light to allow the operator or the on-site manager to quickly recognize the abnormal situation. This alarm performs an essential function to ensure the safety of the operators on site and allows an immediate response in the site.

The security module 2100 is included in the network 2000 to securely protect data transmitted from the 360-degree streaming device 1000 to the web server 2200. The security module 2100 prevents outside attacks or data leakage through the firewall and encryption technology and encrypts all the data transmitted through the network to maintain the integrity and the confidentiality.

By doing this, remote users which access the system may securely check the data and monitor the streaming image and also block attempts for irregularly manipulating or stealing the data, thereby minimizing security risks. During the data transmission process, the security module 2100 encrypts, processes, and protects the data to safely reach the client terminal 2300.

The web server 2200 serves to transmit and stream 360-degree image data and the environment data processed in the embedded module 1300 and the data analysis unit 1400 to the remote user through the web page in real time. The web server 2200 is directly accessed from a device, such as various smart phones, tablets, and PCs without a separate dedicated device, so that the efficiency is maximized. Further, the web server is accessible only through the web browser without installing an app, to offer simple usability and excellent accessibility.

The web server 2200 is designed to securely receive data collected in the workplace through the encryption module 1500 and simultaneously provide the data to a plurality of clients. The data transmitted to the web server 2200 is protected by the security module 2100 including the firewall and all the data is securely encrypted. By doing this, when the data is accessed from the outside, the security risk may be minimized.

First, the web server receives the 360-degree image data processed in the embedded module 1300 and data analyzed in the AI computation module 1410 and the sensor analysis module 1420 in real time. At this time, the data is protected by the encryption module 1500 and the web server 2200 securely processes the data to transmit the data to the client terminal 2300 of the remote user. The client terminal 2300 may include a PC, a smart phone, a tablet, or the like. The user accesses the web server through the web browser and the dedicated application to identify the 360-degree image with various resolutions such as 1 K, 2 K, and 4 K, in real time.

The web server 2200 performs simple streaming and also transmits the outlier or the risk signal detected by the AI computation module 1410 and the sensor analysis module 1420 together. For example, when an operator enters a dangerous zone or a gas concentration exceeds a dangerous level, the warning signal is transmitted to the remote user through the web server 2200 in real time. This not only notifies the warning in the site, but also allows the remote user to recognize the warning and immediately respond.

Further, the web server 2200 provides a stable streaming environment to allow a plurality of users to simultaneously access and is designed to smoothly process the data without causing conflicts between users. The system may be efficiently operated with a smaller number of people and the state of the workplace may be monitored in real time regardless of the physical distance so that the system may be built and operated with less cost in a larger region. The data may be checked and responded to in an environment with an enhanced security and the function addition and the update may be conveniently performed.

The client terminal 2300 is a device which receives the 360-degree image data transmitted from the web server 2200 in real time and the environment data and may include various devices, such as a PC, a smart phone, or a tablet. These devices access the web server through the web browser or the dedicated application to allow the user to monitor the state of the workplace in real time and respond to the warning signal if necessary.

Specifically, the client terminal 2300 is accessible only by the web browser without installing the app to be easily accessed to the system without installing a separate software and has excellent accessibility and the usage convenience. The user may identify the streaming image in real time with various resolutions, such as 1 K, 2 K, and 4 K, through the client terminal and identify the outlier or the risk signal detected by the AI computation module 1410 and the sensor analysis module 1420 in real time.

Even though a plurality of users simultaneously accesses, the client terminal 2300 may provide a smooth streaming environment, thereby monitoring the workplace in everywhere and quickly responding.

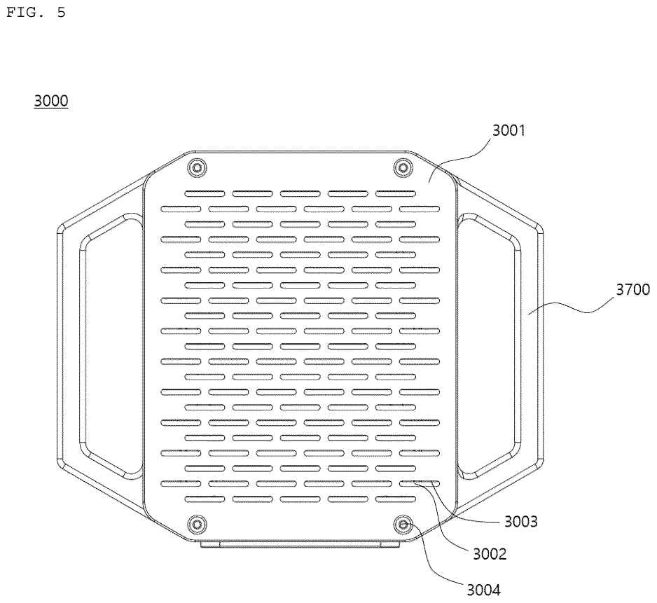

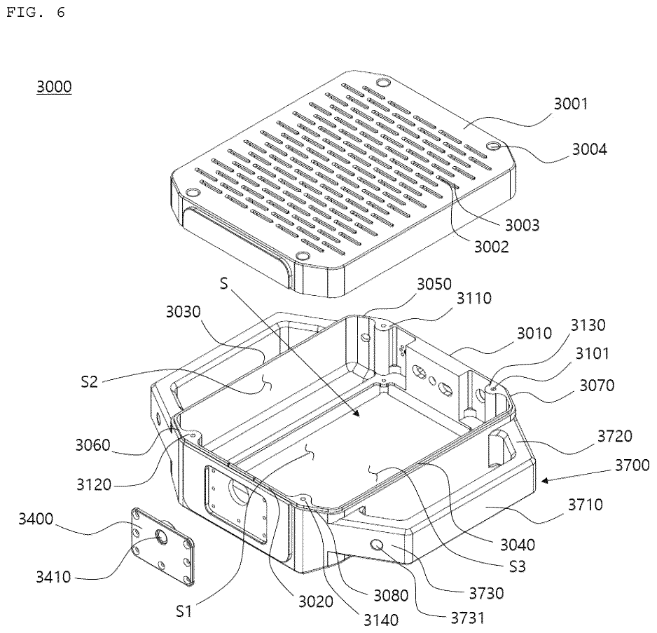

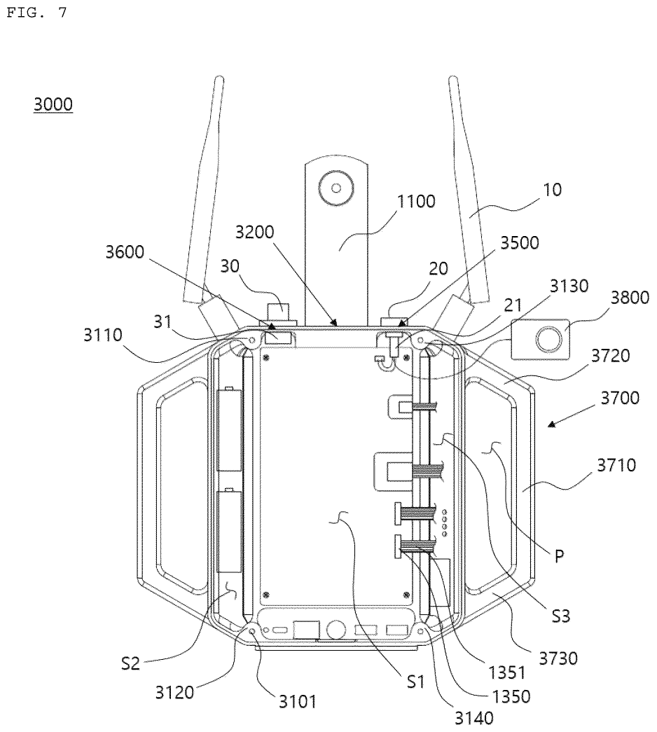

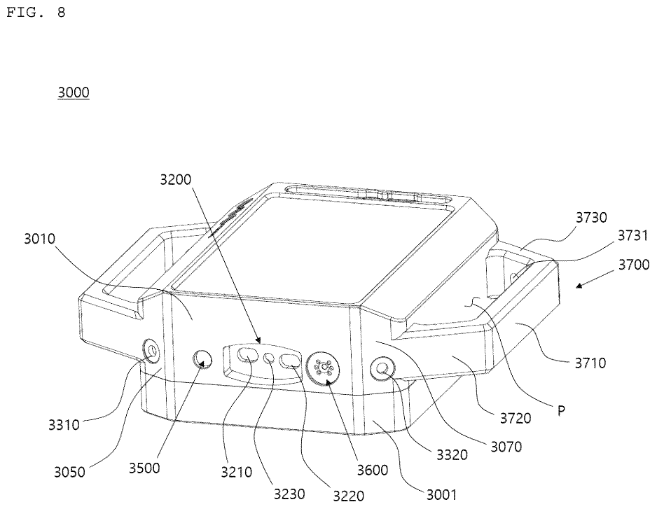

FIG. 5 is a view illustrating a state in which a housing for coupling an embedded module and a 360-degree camera is coupled to a cover, in a 360-degree streaming device according to the present disclosure. FIG. 6 is a view illustrating a state in which a housing of FIG. 5 is separated from a cover. FIG. 7 is a plan view of a housing according to the present disclosure.

In the 360-degree streaming device 1000 according to the present disclosure, the housing 3000 for coupling the embedded module and the 360-degree camera will be described with reference to FIGS. 5 to 7, as follows.

In the present disclosure, the 360-degree streaming device 1000 of the 360-degree image real-time streaming and environment analysis system is integrated in one housing 3000. The housing 3000 is configured to be covered by a cover 3001 and a plurality of ventilation holes 3002 is formed on the cover 3001. In each ventilation hole 3002, an inclined portion 3003 is formed to be inclined toward the inside of the housing 3000 to block the internal configurations of the housing 3000 from being seen from the outside.

A first coupling hole 3004 is formed in a portion of each corner of the cover 3001 corresponding to first to fourth fitting protrusions 3110, 3120, 3130, and 3140 of the housing 3000 and a corresponding second coupling hole 3101 is formed in each of the first to fourth fitting protrusions 3110, 3120, 3130, and 3140. A fixture (not illustrated) is coupled to the first coupling hole 3004 and the corresponding second coupling hole 3101 while covering the housing 3000 with the cover 3001 to couple the cover 3001 with the housing 3000.

The 360-degree camera 1100 and the embedded module 1300 are coupled to the housing 3000. The embedded module 1300 is a board shape and the AI computation module 1410 and the sensor analysis module 1420 described above are mounted. The housing 3000 includes an inner space S enclosed by an upper wall 3010, a lower wall 3020, and both side walls 3030 and 3040.

The inner space S includes a board mounting space S1, a battery storage space S2, and a wired line extension space S3.

The board mounting space S1 is located in a center of the inner space S of the housing 3000 and is designed to allow the embedded module 1300 to be securely mounted and protected. The board mounting space S1 is located between the upper wall 3010 and the lower wall 3020 of the housing 3000 and is formed in an intermediate part of both side walls 3030 and 3040. Four fitting protrusions 3110, 3120, 3130, and 3140 are provided in the board mounting space S1 to fix four corners of the embedded module 1300.

Four fitting protrusions 3110, 3120, 3130, and 3140 are configured by first and third fitting protrusions 3110 and 3130 protruding downwardly from the inside of the upper wall 3010 and second and fourth fitting protrusions 3120 and 3140 protruding upwardly from the inside of the lower wall 3020. The first and third fitting protrusions 3110 and 3130 are spaced apart from each other in a width direction of the housing 3000 and the second and fourth fitting protrusions 3120 and 3140 are spaced apart from each other in a width direction of the housing 3000.

The first to fourth fitting protrusions 3110, 3120, 3030, and 3140 are engaged with four corners of the embedded module 1300 to securely fix the embedded module 1300 so as not to be shaken or damaged in the housing. The embedded module 1300 is designed to be securely fixed to the inside of the housing 3000 and to this end, the first to fourth engagement surfaces 1310, 1320, 1330, and 1340 are formed in four corners of the embedded module 1300. The first to fourth engagement surfaces 1310, 1320, 1330, and 1340 are designed to be concave so as to correspond to the first to fourth fitting protrusions 3110, 3120, 3130, and 3140 provided inside the housing 3000 so that the embedded module 1300 may be securely fixed in the housing.

In the meantime, a USB coupling unit 1350 has a structure formed to extend a USB port 1351 of the embedded module 1300 located in the housing 3000 to the outside of the housing. One end of the USB port 1351 is connected to the embedded module 1300 and the other end is exposed to the outside of the housing to be connected to the external device.

The board mounting space S1 is located between the battery storage space S2 and the wired line extension space S3 and the spaces are divided with respect to the first to fourth fitting protrusions 3110, 3120, 3130, and 3140. The first and second fitting protrusions 3110 and 3120 located at the left side partition the battery storage space S2 and the board mounting space S1 and the third and fourth fitting protrusions 3130 and 3140 located at the right side partition the wired line extension space S3 and the board mounting space S1. The partition suppresses the interference between internal components, clarifies the function of each space, and increases the easiness of maintenance and assembly.

The battery storage space S2 is an area located at the left side of the board mounting space S1 in the inner space S of the housing 3000. This space is enclosed by a left side wall 3030, the first fitting protrusion 3110, and the second fitting protrusion 3120 of the housing 3000 and extends in a vertical direction.

The battery storage space S2 is an independent space located at the left side of the inside of the housing 3000 and is separated from the board mounting space S1. This space is clearly divided according to a structural feature of the housing 3000 and is designed to securely accommodate the battery.

An upper boundary of the battery storage space S2 is formed by a first inclined surface 3050 and the first inclined surface 3050 connects the upper wall 3010 and the left side wall 3030 of the housing 3000 to restrict an upper end of the battery storage space S2. A lower boundary is formed by the second inclined surface 3060 and the second inclined surface 3060 defines a lower end of the space by connecting the lower wall 3020 and the left side wall 3030 of the housing 3000. The left boundary of the space is configured by the left side wall 3030 of the housing 3000 and the right boundary is formed by the first and second fitting protrusions 3110 and 3120 to be separated from the board mounting space S1.

The battery storage space S2 has a rectangular inner space extending along a height of the housing 3000 and has sufficient depth and width to stably place the battery. The inside of the battery storage space S2 has a flat bottom structure to fix the battery and is designed to connect six batteries in parallel. This structure suppresses the movement or shaking of the battery and safely supplies the power.

The wired line extension space S3 is an independent space located at the right side of the inside of the housing 3000 and is separated from the board mounting space S1 and is designed to move and organize the wired line. This space is divided so as to suppress interference between components in the housing and stably extend the wired line.

The left boundary of the wired line extension space S3 is formed by the third and fourth fitting protrusions 3130 and 3140 and the third and fourth fitting protrusions 3130 and 3140 partition the board mounting space S1 and the wired line extension space S3. The right boundary of the space is formed by the right side wall 3040 of the housing 3000 and the upper boundary is formed by the third inclined surface 3070. The third inclined surface 3070 connects the upper wall 3010 and the right side wall 3040 of the housing to restrict the upper end of the space. The lower boundary is formed by the fourth inclined surface 3080 and the fourth inclined surface 3080 defines a lower end of the wired line extension space S3 by connecting the lower wall 3020 and the right side wall 3040 of the housing 3000.

The inside of the wired line extension space S3 is designed to have a rectangular structure extending along the height of the housing 3000 to provide a sufficient available space to place the wired line and smoothly move. The inside has a flat and smooth bottom structure so as to prevent the wired line from twisting and being damaged and a wired line extending from the embedded module 1300 to be organized and accommodated at the right side or be connected to the outside.

FIG. 8 is a top view of a housing according to the present disclosure.

Referring to FIG. 8, a camera connection unit 3200 has a recessed structure formed in the middle of the upper wall 3010 of the housing 3000 and is designed to allow the 360-degree camera 1100 to be securely coupled. The recess is dented into the housing upper wall 3010 to a predetermined depth so that when the 360-degree camera 1100 is coupled, the lower end of the 360-degree camera 1100 which outwardly protrudes is securely fixed.

Three holes are formed on the bottom of the camera connection unit 3200 and two holes located on both sides are first and second direction switching holes 3210 and 3220 to switch the direction of the 360-degree camera 1100 and one center hole is formed as a fixing hole 3230 to fix the 360-degree camera 1100 to the housing.

The first and second direction switching holes 3210 and 3220 are configured to be engaged with a pin or a protrusion to switch a direction of a main body of the 360-degree camera 1100. By doing this, the 360-degree camera 1100 may be engaged toward the front side or be coupled toward the rear side. By doing this, the direction of the 360-degree camera 1100 may be switched.

A screw thread is formed in the fixing hole 3230 to allow a fixing bolt to be inserted so that the 360-degree camera 1100 is detachably coupled to form firm coupling without shaking.

The side wall of the camera connection unit 3200 is vertically formed and has a smooth structure to minimize the interference when the 360-degree camera 1100 is coupled. The bottom is designed to be flat and uniform to stably maintain the coupling position of the 360-degree camera 1100. By doing this, the 360-degree camera 1100 may be closely fixed in the recess of the camera connection unit 3200.

First and second antenna coupling units 3310 and 3320 are formed on the first inclined surface 3050 and the third inclined surface 3070 which connect the upper wall 3010 and both side walls 3030 and 3040 of the housing 3000. The first and second antenna coupling units 3310 and 3320 are formed as through-holes designed to allow the antenna 10 to be firmly coupled to the housing 3000. A screw thread is formed inside to be coupled to a screw of the antenna 10 to provide fixing and supporting. One end of the antenna 10 may be coupled to the first and second antenna coupling units 3310 and 3320 and the other end may extend to the outside of the housing 3000. However, an internal antenna disposed in the housing 3000 may be applied without being limited thereto.

The first antenna coupling unit 3310 is disposed in the center of the first inclined surface 3050 which connects the upper wall 3010 and the left side wall 3030 of the housing or a location appropriate for the antenna position. In contrast, the second antenna coupling unit 3320 is formed on the third inclined surface 3070 which connects the upper wall 3010 and the right side wall 3040 of the housing in the same manner.

The first and second antenna coupling units 3310 and 3320 are located on the inclined surfaces 3050 and 3070 of the housing 3000 to maintain a smooth exterior design of the housing and efficiently utilize the inner space. This structure is appropriate for designing to couple the internal antenna if the antenna 10 is not desired to be exposed to the outside. In this case, the internal antenna may be disposed using an empty space in the battery storage space S2 and the wired line extension space S2.

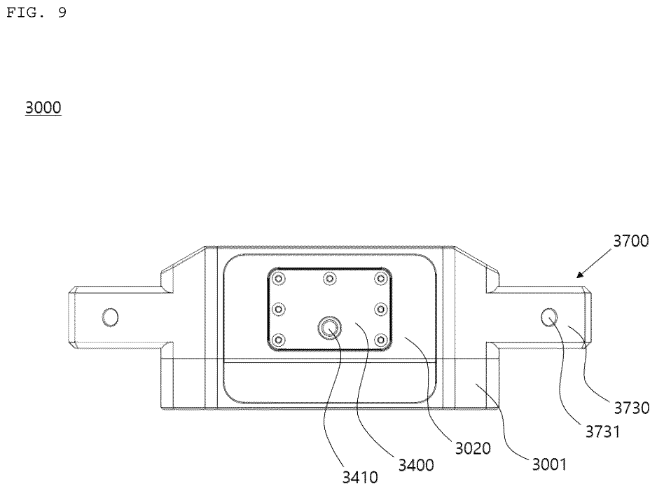

FIG. 9 is a bottom view of a housing according to the present disclosure.

Referring to FIG. 9, a screw hole 3410 is formed on the lower wall 3020 of the housing 3000 and passes through the lower wall to be coupled to the tripod (not illustrated) and has a screw thread formed therein. A detachable plate 3400 is detachably formed on the lower wall 3020 of the housing 3000 and the screw hole 3410 is formed in the detachable plate 3400. A detachable plate 3400 having a screw hole 3410 in accordance with a type of a coupling unit of the tripod to be coupled may be replaced. The screw thread is designed to be coupled with the screw of the tripod, thereby fixing the housing 3000 to the tripod. The screw 3410 is located in the center of the lower wall 3020 of the housing 3000 and when the screw hole is assembled with the tripod, the housing is stably held.

The LED coupling unit 3500 has a recessed structure formed on the upper wall 3010 of the housing 3000 and is configured to allow an LED 20 to be securely mounted. The LED coupling unit 3500 is dented inwardly from the upper wall 3010 of the housing and an inner space is provided to allow a lower end of the LED to pass through the upper wall of the housing to be coupled. The LED coupling unit 3500 is located on the upper wall 3010 of the housing to be opposite to a gas sensor coupling unit 3600 with a camera connection unit 3200 therebetween.

A structure which is coupled to the fixture 21 which fixes the LED 20 is included on the lower surface of the LED coupling unit 3500. The fixture coupling structure has an appropriate size and position to fix the lower end of the LED 20 and helps the LED 20 to be mounted detachably from the housing 3000. Further, the LED coupling unit 3500 is designed to be compatible with an LED 20 with various shapes and sizes to be standardized to be coupled with a normal LED module.

According to the exemplary embodiment of the present disclosure, the gas sensor coupling unit 3600 has a recessed structure formed on the upper wall 3010 of the housing 3000 and is configured to allow a gas sensor 30 to be securely coupled. The gas sensor coupling unit 3600 is inwardly dented from the upper wall 3010 of the housing and provides an inner space to allow a lower end of the gas sensor 30 to be fixed to the upper wall of the housing. The gas sensor coupling unit 3600 is located on the upper wall 3010 of the housing to be opposite to the LED coupling unit 3500 with a camera connection unit 3200 therebetween.

The gas sensor coupling unit 3600 includes a fixture (31) coupling structure to firmly fix the coupled gas sensor 30. The recessed shape of the gas sensor coupling unit 3600 is formed to match the size and the shape of the lower end of the gas sensor 30 and is standardized to be compatible with various gas sensor modules. The fixture coupling structure is designed to support a screw or clip type fixing mechanism to fix the gas sensor 30.

Handles 3700 are structures formed on both side walls 3030 and 3040 of the housing 3000 and are designed to allow the user to easily hold and carry the housing 3000. The handle 3700 is spaced apart from the side walls 3030 and 3040 of the housing 3000 with a predetermined distance and includes a hand insertion space P therein. The hand insertion space P is enclosed by a vertical extension portion 3710, an upper inclined portion 3720, and a lower inclined portion 3730.

The vertical extension portion 3710 extends to be parallel to the housing side walls 3030 and 3040 and is formed to be shorter than the housing side walls 3030 and 3040. The vertical extension portion 3710 has sufficient height and thickness to allow the user to hold the housing 3000 and configures a center portion of the handle 3700. The upper inclined portion 3720 is an inclined structure which connects an upper end of the vertical extension portion 3710 and upper ends of the housing side walls 3030 and 3040 and smoothly connects the upper end of the handle 3700. The lower inclined portion 3730 is an inclined structure which connects a lower end of the vertical extension portion 3710 and lower ends of the housing side walls 3030 and 3040 and smoothly connects the lower end of the handle 3700.

An overall structure of the handle 3700 is designed to be securely held when the user's hand is inserted and is formed on both side walls 3030 and 3040 of the housing 3000 so that it is suitable to be carried while being held with both hands. According to the exemplary embodiment, the handle 3700 may be formed only one side wall of the housing 3000. The configuration of the handle 3700 is formed of a material which is sufficiently thick and firm to ensure the strength and the durability and is integrally manufactured with the housing 3000 or separately attached to the housing.

A locking device hole 3731 is a through hole formed on the lower inclined portion 3730 of the handle 3700 and is a structural element to physically fix the housing 3000. The locking device hole 3731 is to couple a locking device (not illustrated) to restrict the movement of the housing 3000. The locking device hole 3731 is located in an intermediate location of the lower inclined portion 3730 and a diameter is designed to have an appropriate size to support insertion and fixing of the locking device (not illustrated).

The locking device hole 3731 passes through the lower inclined portion 3730 of the handle to allow the hand insertion space P and the external space to communicate with each other, thereby inserting the locking device from one side and expanding and fixing the locking device to an opposite side. The locking device hole 3731 is used to temporarily fix while carrying the housing 3000 or suppress loss.

A buzzer 3800 configures an alarm module 1700 and is a component which is disposed in the housing 3000, specifically, in an upper area of the module mounting space 3100. The buzzer 3800 is a device which generates sound and operates by being connected with an internal circuit and is designed to be fixed in the housing 3000.

A terminal is formed in the buzzer 3800 to be connected to the embedded module 1300. This terminal electrically connects the buzzer to be supplied with a power required to generate a sound or receive a signal. The outside of the buzzer is formed of a solid plastic to protect the buzzer from an impact or a vibration which may be generated in the housing.

The protection scope of this field is not limited to the description or the expression of the exemplary embodiment which has been clearly described above. Further, it is added once again that the protection scope of the present disclosure may not be limited due to obvious changes or substitutions in the technical field to which the present invention belongs.

What is claimed is:

1. An embedded module and 360-degree camera-integrated 360-degree streaming device, comprising:
a housing having an inner space enclosed by an upper wall, a lower wall, and both side walls,
wherein the inner space of the housing includes a module mounting space formed to mount the embedded module, a battery storage space formed at one side of the module mounting space, and a wired line extension space formed at a right side of the module mounting space, a camera connection unit to which the 360-degree camera is coupled is formed on the upper wall of the housing, and a handle is coupled to at least one of the both side walls to allow an operator to hold and carry the housing.

2. The 360-degree streaming device according to claim 1, wherein first to fourth fitting protrusions which fix four corners of the embedded module are formed in the inner space of the housing, and the first and third fitting protrusions downwardly protrude while being spaced apart from each other in a width direction in the upper wall of the housing and the second and fourth fitting protrusions upwardly protrude while being spaced apart from each other in a width direction in the lower wall of the housing.

3. The 360-degree streaming device according to claim 2, wherein in the embedded module, first to fourth engagement surfaces are formed on corners of the embedded module to be engaged with the first to fourth fitting protrusions, respectively.

4. The 360-degree streaming device according to claim 2, wherein the first and second fitting protrusions divide the module mounting space and the battery storage space and the third and fourth fitting protrusions divide the module mounting space and the wired line extension space.

5. The 360-degree streaming device according to claim 1, wherein the camera connection unit formed on the upper wall of the housing is recessed to allow a lower end of the 360-degree camera to be mounted, and a direction switching hole for switching a direction of the 360-degree camera and a fixing hole for fixing the 360-degree camera are formed on an inner surface of the recess to couple the 360-degree camera to be detachable and switch the direction.

6. The 360-degree streaming device according to claim 1, wherein first and third inclined surface are formed between the upper wall and the both side walls of the housing, respectively, and second and fourth inclined surfaces are formed between the lower wall and the both side walls of the housing, respectively, the first and third inclined surfaces connect the upper wall and the both side walls of the housing, and the second and fourth inclined surfaces connect the lower wall and the both side walls of the housing to allow edges of the housing to be smoothly continued.

7. The 360-degree streaming device according to claim 6, wherein first and second antenna coupling units to which an antenna is detachably coupled are formed on the first and third inclined surfaces formed between the upper wall and the both side walls of the housing and the first and second antenna coupling units are formed as through holes to include a screw thread therein and the antenna is screwed with the housing through the screw thread.

8. The 360-degree streaming device according to claim 1, wherein the battery storage space formed in the inner space of the housing has a right side restricted by the first fitting protrusion and the second fitting protrusion of the housing and a left side enclosed by the left side wall of the housing to securely accommodate a battery.

9. The 360-degree streaming device according to claim 1, wherein the wired line extension space formed in the inner space of the housing has a left side restricted by the third fitting protrusion and the fourth fitting protrusion of the housing and a right side enclosed by the right side wall of the housing to organize and protect a wired line.

10. The 360-degree streaming device according to claim 1, wherein a screw hole passes through the lower wall of the housing to fix the housing to a tripod.

11. The 360-degree streaming device according to claim 1, wherein an LED coupling unit and a gas sensor coupling unit are formed on the upper wall of the housing with the camera connection unit therebetween, are formed to have a recess structure which is inwardly dented from the upper wall of the housing, and are coupled to a fixture which fixes an LED and a gas sensor in the recess.

12. The 360-degree streaming device according to claim 1, wherein each of handles formed on the both side walls of the housing includes a hand insertion space to which the user's hand is inserted and the hand insertion space is enclosed by a vertical extension portion which is spaced apart from the side wall of the housing, an upper inclined portion which connects an upper end of the vertical extension portion and an upper end of the side wall of the housing, and a lower inclined portion which connects a lower end of the vertical extension portion and a lower end of the side wall of the housing.

13. The 360-degree streaming device according to claim 12, wherein a locking device hole which passes through the lower inclined portion is formed and allows a locking device to be coupled to restrict movement of the housing.
